(19) United States
(12) Patent Application Publication
(10) Pub. No.: US 2009/0288147 A1
(43) Pub. Date: Nov. 19, 2009

(54) SYSTEM AND METHOD FOR MODIFYING SECURITY FUNCTIONS OF AN ASSOCIATED DOCUMENT PROCESSING DEVICE

(76) Inventors: Michael Yeung, Mission Viejo, CA (US); Amir Shahindoust, Laguna Niguel, CA (US); Girish R. Krishna, Torrance, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/401,085

(22) Filed: Mar. 10, 2009

Related U.S. Application Data
(63) Continuation-in-part of application No. 10/770,985, filed on Feb. 2, 2004, now Pat. No. 7,503,067.

(51) Int. Cl. G06F 21/00

(52) U.S. Cl. 726/4

(57) ABSTRACT

The subject application is directed to a system and method for modifying at least one security function of an associated document processing device. Data representing security functions of the document processing device is stored in associated memory. Login data is then received from an administrator via an associated user interface. Selection data is received corresponding to a security function on the document processing device to be enabled. The selected security function is then selectively enabled via the document processing device. Enhanced mode selection data is then received from the administrator corresponding to an enhanced security mode of operation. Each security function associated with the enhanced mode is simultaneously enabled. Operations of the document processing device are thereafter controlled in accordance with each selectively enabled security function.

### CROSS-REFERENCE TO RELATED APPLICATIONS

This application is a continuation-in-part of U.S. patent application Ser. No. 10/770,985, titled PRESET SECURITY LEVELS, filed Feb. 2, 2004.

### BACKGROUND OF THE INVENTION

The subject application is directed to securing devices. More particularly, the subject application relates to selectively enabling and disabling security functions of an associated document processing device.

Conventionally, computer systems, including peripheral devices, frequently include a plurality of security features, or functions, for providing a more secure operation of the system or device. Such security features typically include port closing features, Telnet deactivation features, SSL activation features, intrusion detection system activation features, etc. Some of these features provide a low level of security, such as the port closing functions, while other functions provide a high level of security, such as the intrusion detection system activation feature. When a system administrator wants to activate a certain level of security, the administrator must manually activate each security feature associated with a particular security level. This can be a tedious and time-consuming process, as the number of security features needed to be activated can be large. Thus, there is a need for a preset security level system and method for using the same

Additionally, performance and security are usually viewed as features highly desirable for data processing peripherals, such as printers and multifunction peripherals. Security-sensitive users, such as government agency employees, health care organization employees, etc., require a peripheral having a high degree of security, but are typically less demanding regarding the performance of the peripheral. Typical users demand a great deal of performance, but have little regard for security. Most peripheral device manufacturers attempt to satisfy these divergent needs by offering a dual line of products, those having enhanced security features and those having enhanced performance features. However, this is an inefficient approach, as a user is not presented with a single peripheral device embodying both features—security and performance. Thus, it is desirable to have a system and method whereby a peripheral device, such as a document processing device, will embody both increased security and performance features.

### SUMMARY OF THE INVENTION

In accordance with one embodiment of the subject application, there is provided a system and method for modifying at least one security function of an associated document processing device. Data representing a plurality of security functions is stored in a memory associated with the document processing device, wherein the security functions correspond to secured operation of the document processing device. Login data is then received corresponding to an identity of an administrator via an associated user interface, and selection data is received from the administrator corresponding to at least one security function on the document processing device to be enabled. The at least one selected security function is then selectively enabled via the associated document processing device. Enhanced mode selection data is then received from the administrator corresponding to an enhanced security mode of operation of the associated document processing device. Each of a plurality of security functions associated with the enhanced mode of operation is then simultaneously enabled via the document processing device. Operations of the document processing device are thereafter controlled in accordance with each selectively enabled security function.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the subject application, and together with the description serve to explain the principles of the subject application. In the drawings:

FIG. 1 is a schematic illustration of an example architecture for implementing the subject application;

FIG. 2 is a block diagram illustrating an example configuration of the preset security level system of the subject application;

FIG. 3 is a flow chart illustrating an example method for using the preset security level system of the subject application;

FIG. 4 is a flow chart illustrating a method for modifying security functions of an associated document processing device in accordance with one embodiment of the subject application;

FIG. 5 is a flow chart illustrating a method for modifying security functions of an associated document processing device in accordance with one embodiment of the subject application;

FIG. 6 is a screen template illustrating a graphical user interface for use in the system and method for modifying security functions of an associated document processing device in accordance with one embodiment of the subject application; and

FIG. 7 is a screen template illustrating a graphical user interface for use in the system and method for modifying security functions of an associated document processing device in accordance with one embodiment of the subject application.

### DETAILED DESCRIPTION OF PREFERRED EMBODIMENT

Disclosed according to the present invention is a peripheral device-oriented preset security level system and a method for using the preset security level system. The system generally includes at least one administrator-selectable security level, function, or mode, the selection of which causes security functions associated with features of the document processing device to operate according to the selected security level. The system additional includes at least one security feature associated with the at least one security level. In operation, the system and method enable an administrator to select a desired level of security and thereby activate security features associated with the selected security level. Because the security features that provide a certain level of security have already been associated with the security level, the administrator is not required to manually activate all the security features that correspond to a desired security level. Such a system allows for flexibility in security level while allowing the document processing device to operate at a peak performance level.

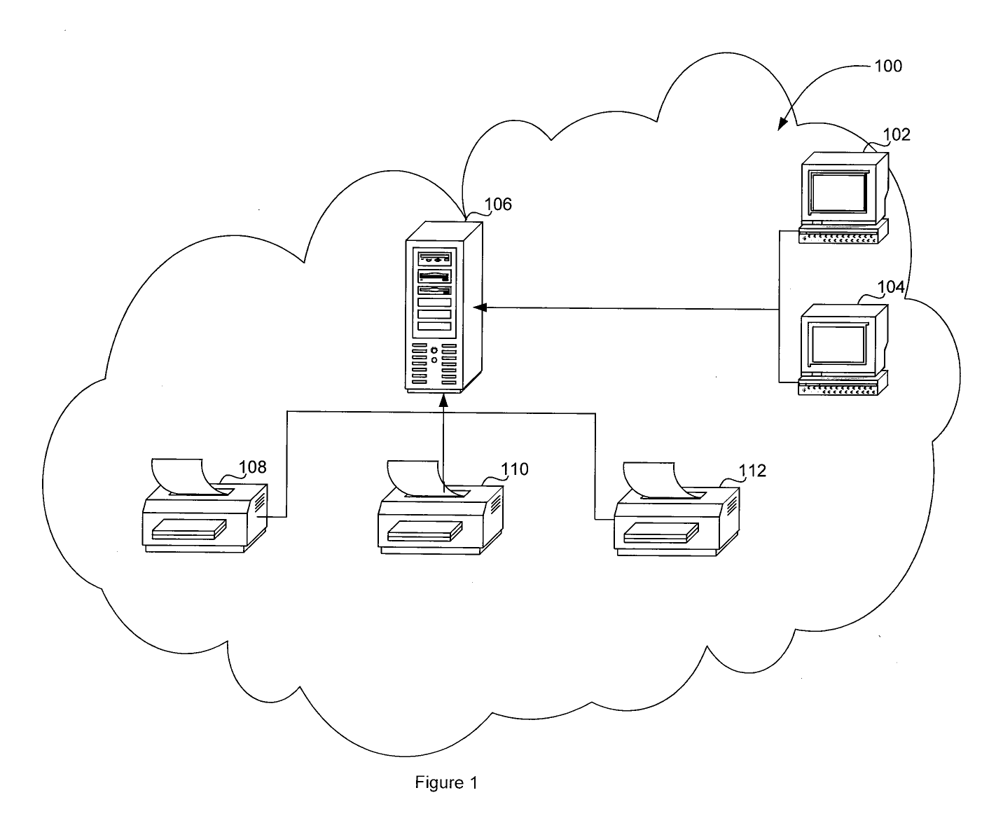

With reference to FIG. 1, illustrated is an example system architecture 100 for implementing the system and method for modifying security functions of an associated document processing device in accordance with one embodiment of the subject application. The architecture 100 suitably includes at least one computer terminal 102, 104, at least one server 106, and at least one document processing device 108, 110, 112, all interconnected through a network. The system and method are adapted to enable secure operation of a document processing device through the activation of security features. The document processing device is any suitable device, such as a copier, a printer, a multifunction peripheral, etc. The system is adapted to be accessible to the administrator through one of the computer terminals 102, 104, through the server 106, through the document processing device 108, 110, 112 itself (through, for example, a control screen associated with the document processing device), etc. Thus, for example, an administrator suitably selects a security level for the document processing device 108 through the computer terminal 102. Additionally, the system is adapted to enable the administrator to select a security level to be operable in a plurality of document processing devices. Thus, for example, the administrator suitably accesses the system through the computer terminal 102, 104, through the server 106, or other suitable means, and suitable selects a security level to be operable in document processing device 108, document processing device 110 and document processing device 112.

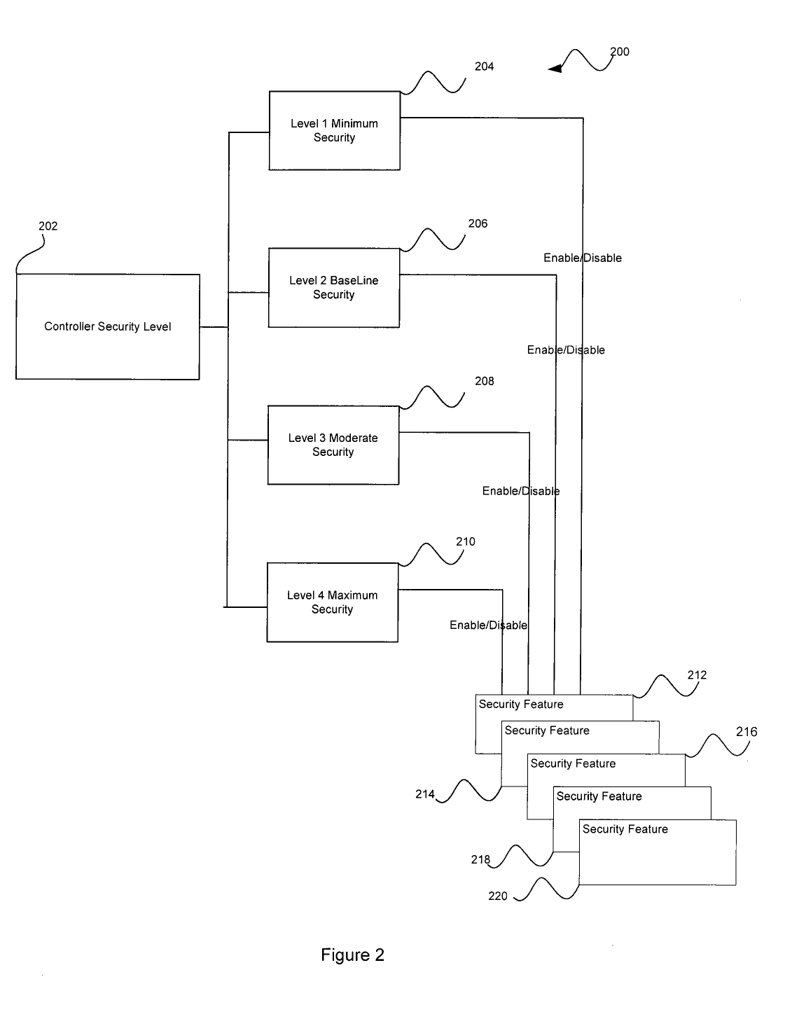

With reference to FIG. 2, the preset security level system 200 generally includes at least one security level and at least one security feature, or function, associated with the at least one security level. According to an example embodiment, the system includes a plurality of security levels 202, such as a first security level 204, a second security level 206, a third security level 208, a fourth security level 210, etc. Each security level suitably enables a different level of secure operation of the peripheral. For example, the first security level 204 suitably enables minimum security, the second security level 206 suitably enables baseline security, the third security level 208 suitably enables moderate security, the fourth security level 210 suitably enables maximum security, etc. Thus, each security level suitably corresponds to a progressively more secure level of operation for the document processing device 108, 110, or 112.

Each security level corresponds to a level of security due to at least one associated security feature. With further reference to FIG. 2, each security level is associated with at least one security feature. With reference to an example embodiment discussed above, the first security level 204 suitably enables a minimum level of security. Accordingly, the first security level 204 is suitably associated with minimum security level security features 212-220 including, but not limited to, disabling Telnet, disabling a keyboard, disabling video services, closing any and all unnecessary ports, etc. The second security level 206 suitably enables a baseline security. Accordingly, the second security level 206 is suitably associated with baseline security level security features 212-220 including, but not limited to, using SSL (Secure Sockets Layer), activating user authentication, using role-based access control, minimizing shared folder use, activating job log protection, enabling secure erase (e.g., image overwrite), encrypting user data, etc. The third security level 208 suitably enables a moderate level of security. Accordingly, the third security level 208 is suitably associated with moderate security level security features 212-220 including, but not limited to, enabling secure print, secure fax, secure scan, secure copy, enabling access control, enabling non-repudiation, etc. The fourth security level 210 suitably enables a maximum level of security. Accordingly, the fourth security level 210 is suitably associated with maximum security level security features 212-220 including, but not limited to, enabling logging for auditing purposes, activating antiviral protections, etc.

Each of the security levels suitably operates as a progressively more secure level, such that the second security level 206 incorporates all of the security features of the first security level 204 and adds additional security features, and the third security level 208 incorporates all of the security features of the second security level 206 (and thereby the first security level 204) and adds additional security features, etc. Additionally, one or more of the security levels suitably has associated therewith such security features so as to be compatible with an ISO (International Organization for Standardization) standard, such as ISO 15408.

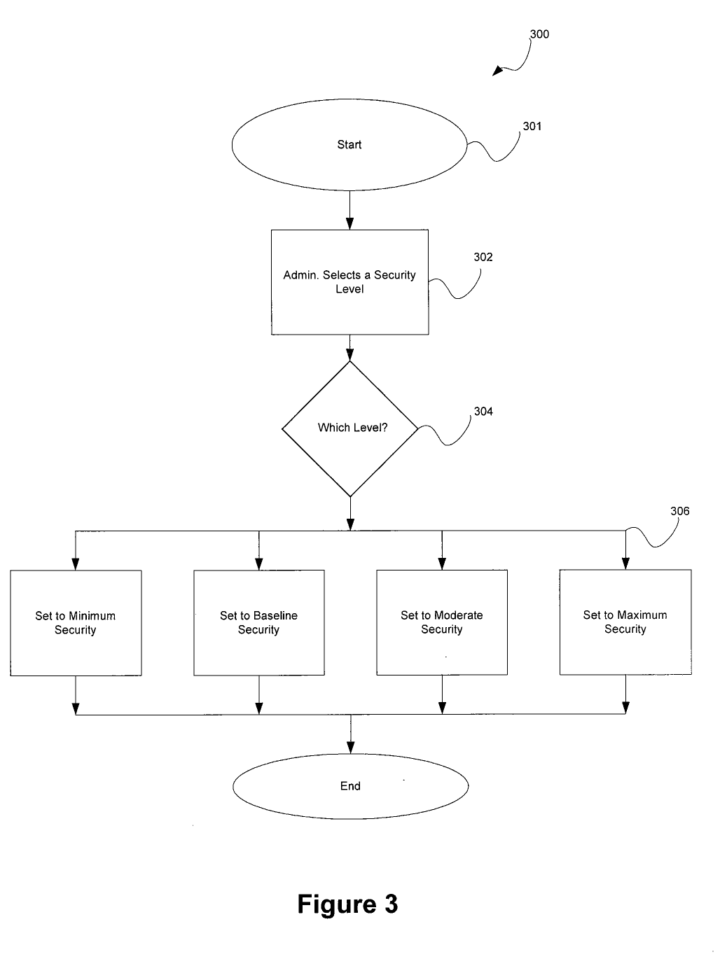

Turning to FIG. 3, illustrated is an example method 300 for using a preset security level system in accordance with one embodiment of the subject application. According to this example, a user, such as a system administrator, first accesses the security system (step 301) through any suitable means as discussed above. Upon so accessing, the administrator is suitably presented with the option of selecting at least one of the preset security levels (step 302). Thereupon, the administrator will select the desired security level at step 304. Upon selecting the desired security level, the desired security level will be activated (step 306). For example, if the administrator selects the first security level, the security features associated with the first security level will be activated. Thereafter, the activated security features will enable the desired level of security for the document processing device.

According to an example embodiment, the administrator will be provided with an option to deselect a selected security level. Accordingly, the system and method are further adapted to enable the administrator to manually deselect a security level or to enable the administrator to specify an event, the passage of which will cause the selected security level to be automatically deselected. For example, the administrator suitably may specify that the security level is to be deselected after a certain time duration or upon the completion of a certain job.

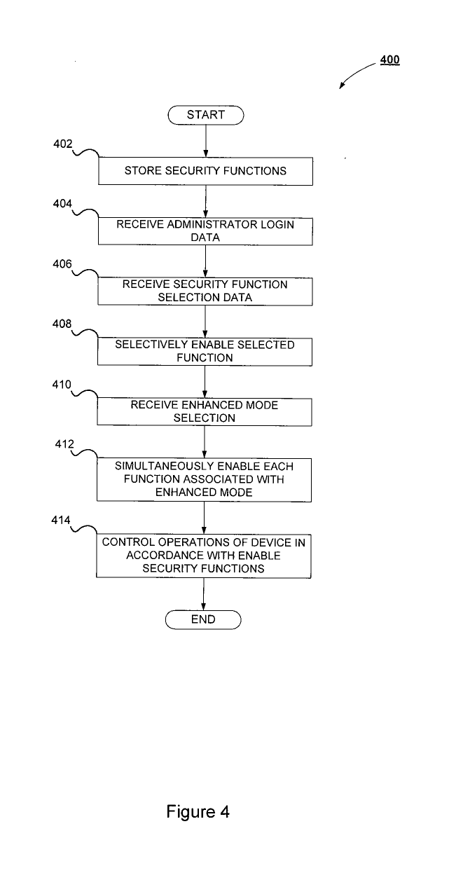

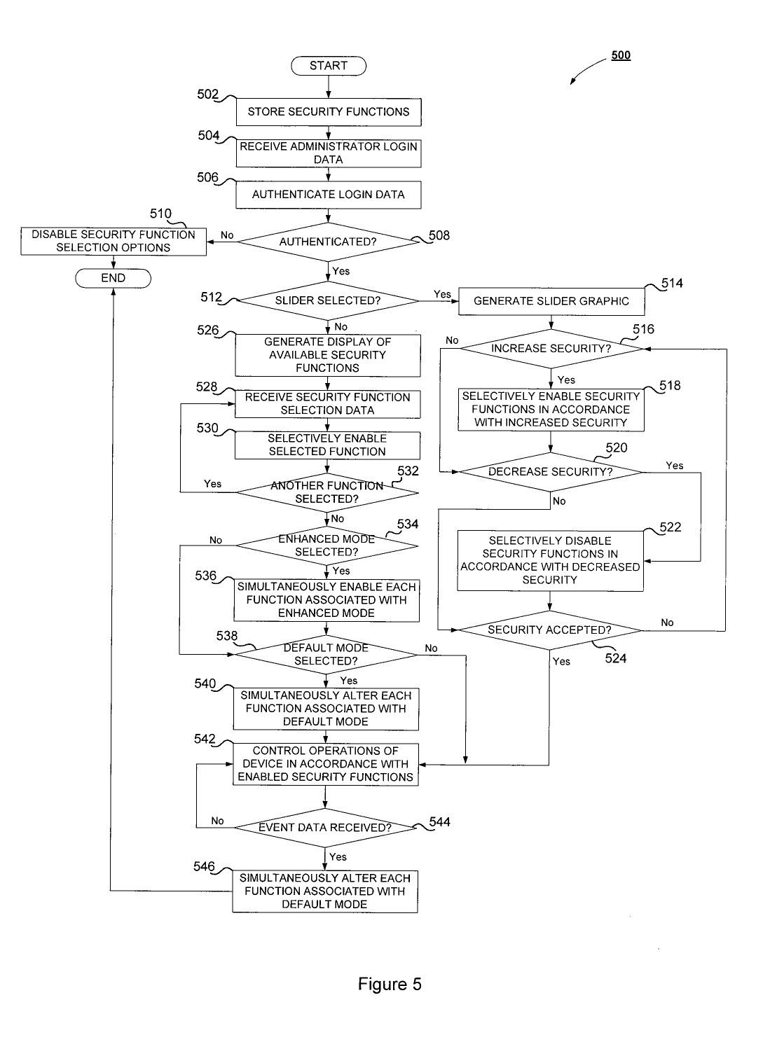

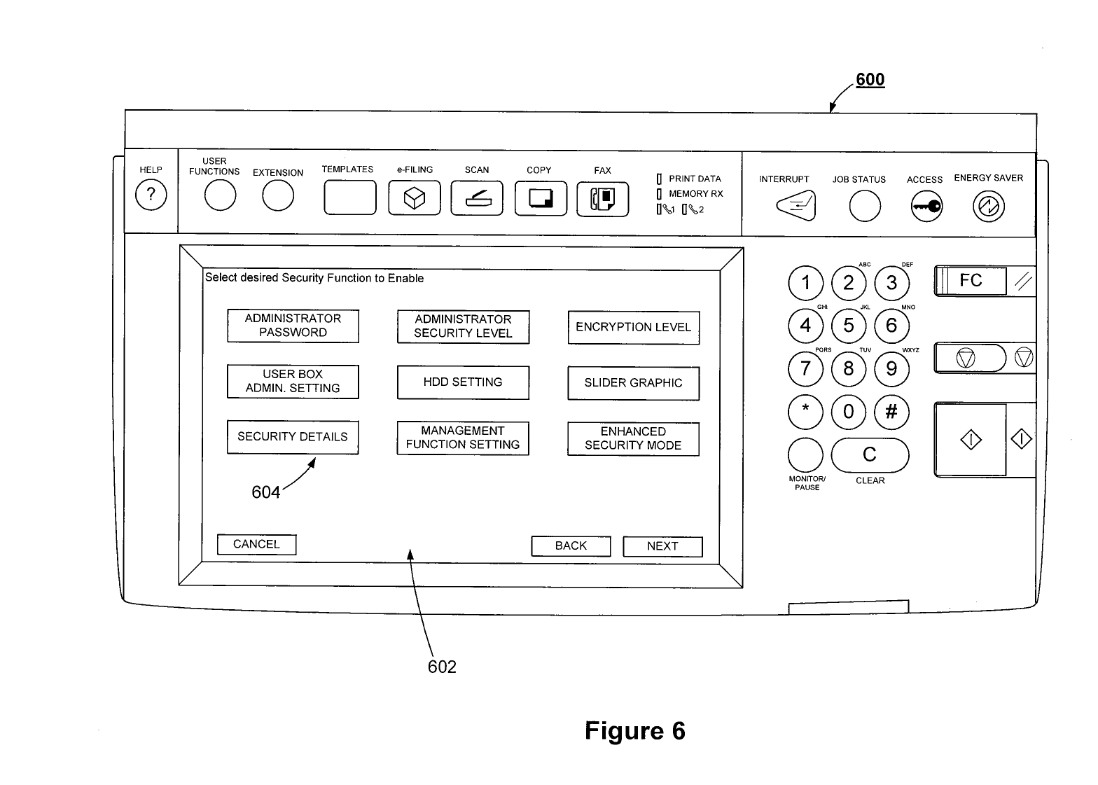

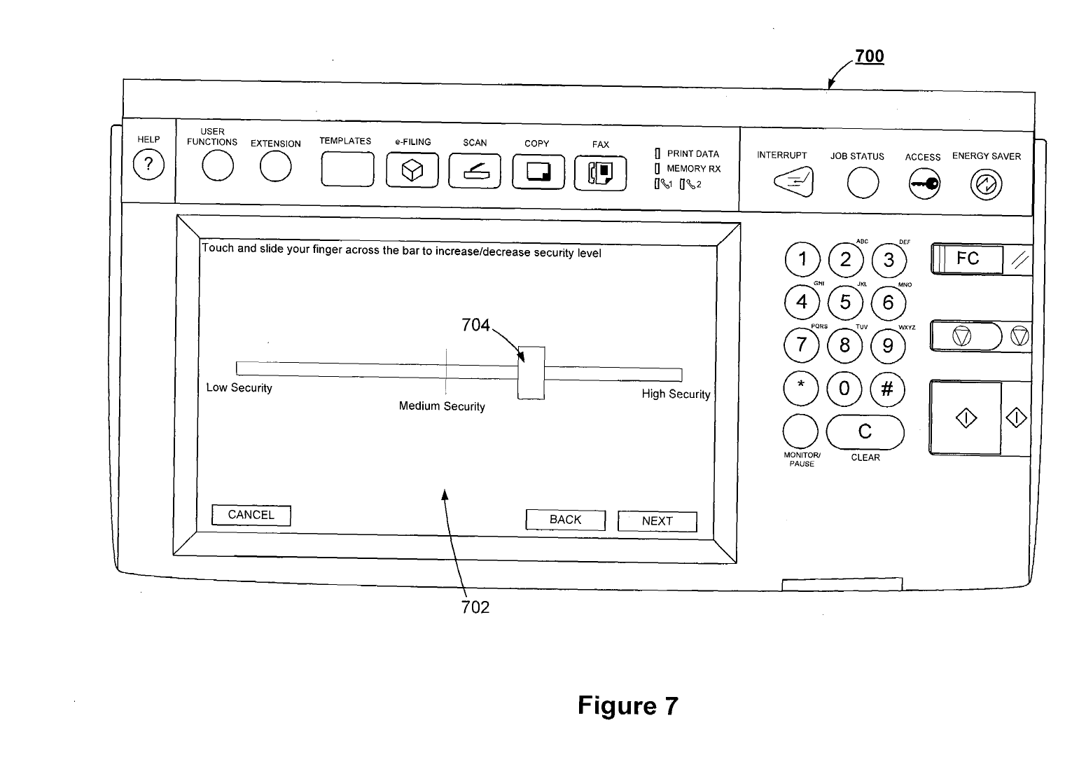

Turning now to FIG. 4, there is shown a flowchart 400 illustrating a method for modifying at least one security function of an associated document processing device in accordance with one embodiment of the subject application. The skilled artisan will appreciate that the security functions referenced hereinafter with respect to FIG. 4, FIG. 5, FIG. 6, and FIG. 7 correspond to the security features of the document processing devices 108, 110, and 112 as referenced above, and as such, either term is used interchangeably hereinafter. As shown in FIG. 4, the methodology begins at step 402, whereupon data representative of a plurality of security functions corresponding to secured operation of the associated document processing device is stored in an associated memory. At step 404, login data is received via an associated user interface corresponding to an identity of an associated administrator.

Selection data is then received from the associated administrator at step 406, which selection data corresponds to a selection of at least one security function to be enabled via the associated document processing device. The at least one security function is then selectively enabled in accordance with the received administrator selection data at step 408. At step 410, enhanced security mode selection data representative of an enhanced security mode of operation of the associated document processing device is received from the associated administrator. Each of a plurality of security functions associated with the enhanced security mode is then simultaneously enabled in accordance with the administrator selection data at step 412. At step 414, operations of the associated document processing device are then controlled in accordance with each selectively enabled security function.

Referring now to FIG. 5, there is shown a flowchart 500 illustrating a method for modifying at least one security function of an associated document processing device in accordance with one example embodiment of the subject application. The methodology of FIG. 5 begins at step 502, whereupon a plurality of security functions corresponding to security features capable of being implemented by an associated document processing device 108, 110, or 112 are stored in memory associated therewith. It will be appreciated by those skilled in the art that suitable security functions include, for example and without limitation, password protection, role-based restrictions, document processing operation restrictions, network communication restrictions, document storage, encryption, and the like.

At step 504, login data is received from the administrator via a user interface associated with the document processing device 108, 110, or 112. In accordance with one embodiment of the subject application, the administrator login data includes, for example and without limitation, a username, password, biometric data, or the like. Those skilled in the art will appreciate that while reference is made with respect to FIG. 5 corresponding to an individual document processing device 108, 110, or 112, the subject application is capable of being implemented by any number of suitable document processing devices 108, 110, and 112. The received login data is then authenticated by the document processing device 108, 110, or 112 at step 506. According to one embodiment of the subject application, authentication is performed by an authentication server, e.g. server 106, internally via local storage, or any suitable authentication means as are known in the art. A determination is then made at step 508 whether authentication of the administrator has been successful. Upon a determination at step 508 that authentication failed, flow proceeds to step 510, whereupon the selection of security functions is disabled and the methodology of FIG. 5 terminates thereafter.

When it is determined at step 508 that the administrator has been successfully authenticated, flow proceeds to step 512. At step 512, a determination is made whether the administrator has selected the slider option for security modification via the associated graphical user interface. FIG. 6 illustrates a suitable example embodiment of a user interface 600 associated with the document processing device 108, 110, or 112. As shown in FIG. 6, the user interface 600 includes a display 602 suitably configured to display a plurality of available security functions 604. The skilled artisan will appreciate that suitable displays 602 include, for example and without limitation, LCD, touch screen, LED, CRT, or the like. Upon a selection at step 512 of the slider option, flow proceeds to step 514.

At step 514, a slider graphical user interface is generated as illustrated in FIG. 7. The user interface 700 of FIG. 7 depicts a touch screen display 702 having a slider indicia 704 displayed thereon. A determination is then made at step 516 whether increased security has been selected by the user. That is, whether the user has dragged the indicia 704 farther to the right of the display 702 indicative of an increase in security associated with the document processing device 108, 110, or 112. When it is determined that an increase in security has been selected, flow proceeds to step 518, whereupon security functions associated with an increased security are selectively enabled by the document processing device 108, 110, or 112. Following the enablement of the associated security functions at step 518, or upon a determination at step 516 that an increase in security has not been selected, operations with respect to FIG. 5 progress to step 520.

At step 520, a determination is made whether a decrease in security of the document processing device 108, 110, or 112 has been selected. That is, whether the administrator has moved the indicia 704 to the left of the display 702 indicative of a decrease in the security of the associated document processing device 108, 110, or 112. Following a positive determination at step 520, operations proceed to step 522 whereupon security functions associated with the decreased security are selectively disabled by the associated document processing device 108, 110, or 112. In accordance with one embodiment of the subject application, a listing or other indicia is displayed to the administrator via the display 702 of the security functions that are enabled during an increase in security or disabled during a decrease in security of the associated document processing device 108, 110, or 112.

After decreasing the security of the associated document processing device 108, 110, or 112 at step 522, or upon a determination at step 522 that the security is not decreased, flow progresses to step 524. At step 524, a determination is made whether the modifications to the security of the associated document processing device 108, 110, or 112 have been accepted by the administrator. In the event that the security modifications, i.e. the selectively enabled or disabled security functions, are not accepted, flow returns to step 516. Upon acceptance by the administrator of the changes to the security of the associated document processing device 108, 110, or 112, flow proceeds to step 542. Operations of the associated document processing device 108, 110, or 112 are then controlled in accordance with the enabled or disabled security functions at step 542.

At step 544, a determination is made whether event data has been received corresponding to the occurrence of a preselected event. According to one embodiment of the subject application, the preselected event includes, for example and without limitation, the completion of a document processing operation, the passage of a selected time period, the selection of a series of user inputs, or the like. When such event data has not been received, flow returns to step 542, whereupon the document processing device 108, 110, or 112 is controlled in accordance with the enabled security functions. When it is determined at step 544 that a preselected event has occurred, flow proceeds to step 546, whereupon each function associated with a default mode of operation is simultaneously altered to reflect the default operation. Operations with respect to FIG. 5 thereafter terminate. For example, the administrator is capable of turning the document processing device 108, 110, or 112 off for a preselected period of time and then restarting the device 108, 110, or 112. Following such restart, the device 108, 110, or 112 is capable of returning to a default mode of operation, i.e. each of the security functions associated with the default mode of operation are selectively altered.

Returning to step 512, upon a determination that the slider option has not been selected, flow proceeds to step 526. At step 526, a display of available security functions associated with the document processing device 108, 110, or 112 is generated via an associated user interface. FIG. 6, referenced above, illustrates such a listing on the display 602 of suitably available security functions 604. At step 528, a selection is received from the administrator of a security function to be enabled by the associated document processing device 108, 110, or 112. The selected security function is then selectively enabled by the document processing device 108, 110, or 112 at step 530.

A determination is then made at step 532 whether another function to be enabled has been selected by the administrator. When another function has been selected, flow returns to step 528 for selection and step 530 for the selective enablement thereof. Upon a determination at step 532 that another function has not been selected by the administrator, flow proceeds to step 534. At step 534 a determination is made whether the administrator has selected an enhanced security mode for the associated document processing device 108, 110, or 112. In accordance with one embodiment of the subject application, an enhanced security mode corresponds to a maximum level of security, whereupon multiple security functions are simultaneously enabled. Upon a determination that enhanced security mode has been selected at step 534, flow proceeds to step 536.

At step 536, each security function associated with the enhanced security mode is simultaneously enabled by the associated document processing device 108, 110, or 112. That is, each of the available security functions, e.g. encryption algorithms, password protections, security levels, etc., associated with a heightened level of security are simultaneously enabled on the associated document processing device 108, 110, or 112. After enablement of the enhanced mode, or following a determination that the administrator did not select the enhanced mode at step 534, operations proceed to step 538. At step 538, a determination is made whether or not a default mode of operation has been selected by the administrator. Upon a determination that a default mode of operation has been selected, flow progresses to step 540. At step 540, each security function associated with the default mode of operation is simultaneously altered to reflect the status associated with the default mode, i.e. security functions are either enabled or disabled in accordance with the default settings. It will be appreciated by those skilled in the art that the default mode of operation corresponds to the selective enablement or disablement of security functions associated with normal operations of the document processing device 108, 110, or 112. The skilled artisan will further appreciate that setting such default functionality is capable of being accomplished by the administrator, by the manufacturer, by the service provider, or the like.

After the alteration of security functions at step 540, or upon a determination that the default mode of operation has not been selected, flow proceeds to step 542. At step 542, operations of the associated document processing device 108, 110, or 112 are controlled in accordance with those security functions that have been enabled. That is, those security functions selected by the administrator, those functions associated with the enhanced security mode, or those functions associated with the default mode are used in the control of operations of the associated document processing device 108, 110, or 112. Operations then proceed to step 544 for a determination of whether event data has been received corresponding to the occurrence of a preselected event. If no event data has been received, flow returns to step 542. When a preselected event has occurred, each function associated with a default mode of operation is simultaneously altered to reflect the default operation at step 546, following which control of the document processing device 108, 110, or 112 reverts to default security settings and operations with respect to FIG. 5 terminate.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed is:

1. A system for modifying at least one security function of an associated document processing device comprising:
a memory associated with the document processing device, the memory configured for storing data representative of a plurality of security functions corresponding to secured operation of the associated document processing device;
means adapted for receiving, via an associated user interface, login data corresponding to an identity of an associated administrator;
means adapted for receiving, from the associated administrator, selection data corresponding to at least one security function to be enabled via the associated document processing device;
means adapted for selectively enabling the at least one security function in accordance with the received administrator selection data;
means adapted for receiving, from the administrator, enhanced security mode selection data representative of an enhanced security mode of operation of the associated document processing device;
means adapted for simultaneously enabling each of a plurality of security functions associated with the enhanced security mode upon administrator selection thereof; and
means adapted for limiting operations of the document processing device in accordance with each selectively enabled security function.

2. The system of claim 1, further comprising:
means adapted for generating, via a graphical display associated with the document processing system, indicia representative of a current security level of the document processing system, wherein the current security level corresponds to a number of security functions enabled on the associated document processing device;
means adapted for receiving, via the associated graphical display, user input corresponding to a selection of the indicia; and
means adapted for altering at least one enabled security function current security level of the associated document processing system in accordance with the received user input.

3. The system of claim 2, wherein the indicia is representative of a slide bar graphic, and wherein a selected first direction of movement of the slide bar graphic in accordance with the received user input increases the current security level, and a selected second direction of movement of the slide bar graphic in accordance with the received user input decreases the current security level.

4. The system of claim 3, further comprising:
means adapted for selectively enabling at least one additional security function associated with the current security level in accordance with a selected security level increase; and
means adapted for selectively disabling at least one security function associated with the current security level in accordance with a selected security level decrease.

5. The system of claim 1, further comprising:
means adapted for receiving selection data corresponding to a selection of a default security mode of operation associated with the document processing device;
means adapted for simultaneously altering each of a plurality of security functions in accordance with the received default security mode selection data such that at least one security function of the document processing device is selectively disabled.

6. The system of claim 1, further comprising:
means adapted for receiving event data corresponding to the occurrence of a preselected event, wherein the preselected event is at least one of completion of a document processing operation, passage of a selected time period, and selection of a series of user inputs; and
means adapted for altering an enablement of at least one security function in accordance with received event data.

7. The system of claim 6, further comprising resetting means adapted for resetting the current security level to a default security level, wherein the default security level corresponds to a selective enablement of at least one security function.

8. The system of claim 1, further comprising:
means adapted for authenticating the administrator in accordance with the received login data so as to enable modification of security functions associated with the document processing device;
means adapted for selectively enabling selection of security functions by the administrator in accordance with an output of the authentication means indicative of a successful authentication; and
means adapted for selectively denying selection of security functions by the administrator in accordance with an output of the authentication means indicative of a failed authentication.

9. The system of claim 1, further comprising means adapted for generating, via a graphical display associated with the document processing system, indicia representative of at least one available security function from the plurality of security functions, wherein the administrator selection of at least one security function is received via the selection of at least one displayed indicia corresponding thereto.

10. A method for modifying at least one security function of an associated document processing device comprising the steps of:
storing, in a memory associated with the document processing device, data representative of a plurality of security functions corresponding to secured operation of the associated document processing device;
receiving, via an associated user interface, login data corresponding to an identity of an associated administrator;
receiving, from the associated administrator, selection data corresponding to at least one security function to be enabled via the associated document processing device;
selectively enabling the at least one security function in accordance with the received administrator selection data;
receiving, from the administrator, enhanced security mode selection data representative of an enhanced security mode of operation of the associated document processing device;
simultaneously enabling each of a plurality of security functions associated with the enhanced security mode upon administrator selection thereof; and
controlling operations of the document processing device in accordance with each selectively enabled security function.

11. The method of claim 10, further comprising the steps of:
generating, via a graphical display associated with the document processing system, indicia representative of a current security level of the document processing system, wherein the current security level corresponds to a number of security functions enabled on the associated document processing device;
receiving, via the associated graphical display, user input corresponding to a selection of the indicia; and
altering at least one enabled security function current security level of the associated document processing system in accordance with the received user input.

12. The method of claim 11, wherein the indicia is representative of a slide bar graphic, and wherein a selected first direction of movement of the slide bar graphic in accordance with the step of receiving user input increases the current security level, and a selected second direction of movement of the slide bar graphic in accordance with the step of receiving user input decreases the current security level.

13. The method of claim 12, further comprising the steps of:
selectively enabling at least one additional security function associated with the current security level in accordance with a selected security level increase; and
selectively disabling at least one security function associated with the current security level in accordance with a selected security level decrease.

14. The method of claim 10, further comprising the steps of:
receiving selection data corresponding to a selection of a default security mode of operation associated with the document processing device;
simultaneously altering each of a plurality of security functions in accordance with the received default security mode selection data such that at least one security function of the document processing device is selectively disabled.

15. The method of claim 10, further comprising the steps of:
receiving event data corresponding to the occurrence of a preselected event, wherein the preselected event is at least one of completion of a document processing operation, passage of a selected time period, and selection of a series of user inputs; and
altering an enablement of at least one security function in accordance with received event data.

16. The method of claim 15, wherein the step of altering further comprises resetting the current security level to a default security level, wherein the default security level corresponds to a selective enablement of at least one security function.

17. The method of claim 10, further comprising the steps of:
authenticating the administrator in accordance with the received login data so as to enable modification of security functions associated with the document processing device;
selectively enabling selection of security functions by the administrator in accordance with an output of the authenticating step indicative of a successful authentication; and
selectively denying selection of security functions by the administrator in accordance with an output of the authenticating step indicative of a failed authentication.

18. The method of claim 10, further comprising the step of generating, via a graphical display associated with the document processing system, indicia representative of at least one available security function from the plurality of security functions, wherein the administrator selection of at least one security function is received via the selection of at least one displayed indicia corresponding thereto.
